(19) United States
(12) Patent Application Publication
(10) Pub. No.: US 2018/0026792 A1
(43) Pub. Date: Jan. 25, 2018

(54) METHODS AND SYSTEMS FOR PRIORITIZED AUTHENTICATION BETWEEN MOBILE OBJECTS

(71) Applicants: Elyes BEN HAMIDA, Doha (QA); Muhammad Awais JAVED, Doha (QA)

(72) Inventors: Elyes BEN HAMIDA, Doha (QA); Muhammad Awais JAVED, Doha (QA)

(21) Appl. No.: 15/218,105

(22) Filed: Jul. 25, 2016

(51) Int. Cl. H04L 9/32; H04W 4/06; H04L 29/06; H04L 12/865; H04L 12/863; H04W 12/06; H04W 4/02; H04B 17/318

(52) U.S. Cl. CPC H04L 9/3247; H04W 4/021; H04W 4/02; H04W 4/06; H04B 17/318; H04L 47/6275; H04L 47/6225; H04L 9/3252; H04W 12/06; H04L 63/123

(57) ABSTRACT

Disclosed are system and methods for prioritized authentication between a plurality of mobile objects. The system comprises: at least a safety application module capable of generating periodically or at specific time instants messages having at least current real-time mobility information of at least the mobile object; at least a mobility module capable of continuously tracking a real-time location information of at least the mobile object; at least a security module having at least one of a signature generation module and a signature verification module, wherein the signature generation module is capable of signing messages generated by the safety application module, wherein the signature verification module is capable of prioritizing the verification of exchanged messages between mobile objects; and at least a communication module capable of transmitting the messages signed by the security module through a network.

### CROSS-REFERENCE TO RELATED APPLICATION

This non-provisional patent application claims priority from the U.S. provisional patent application Ser. No. 62/258,547 filed on Nov. 23, 2015, the content of which are incorporated herein by reference.

### FIELD OF THE INVENTION

The present invention relates generally to authentication of mobile objects, and more, specifically to methods and system for prioritized authentication between mobile objects.

### BACKGROUND OF THE INVENTION

Mobile objects exchange periodic messages wirelessly to notify their surrounding about their mobility information (e.g. location, speed, heading, etc.). The exchanged mobility information allows mobile objects to extend their vision beyond line-of-sight and to have a clear picture of surrounding objects. This enables objects to implement various safety applications, such as collision avoidance, obstacle detection, etc. In this context, it is necessary to guarantee the authenticity and integrity of the exchanged mobility information, as well as to ensure the timely delivery of these messages to the surrounding objects.

One typical scenario consists in cooperative safety awareness applications in Vehicular Adhoc Networks (VANETs) or Intelligent Transport Systems (ITS), where each vehicle periodically broadcasts its mobility information within its neighborhood. These broadcast messages are known as Basic Safety Messages (BSMs) in the U.S. WAVE standard and Cooperative Awareness Messages (CAMs) in the European ETSI standard. BSMs messages allow vehicles to extend their vision beyond line of sight and to develop a local dynamic map (LDM) that maintain a clear picture of surrounding traffic.

Since mobile objects, for example, vehicles, make driving decisions based on their LDM, its accuracy is a key application requirement which in turn is dependent on the fidelity of BSMs. A malicious user can severely impact the vehicle safety by injecting false messages in a vehicular network. Hence, authentication is a key procedure in the transmission of BSMs.

Conventional authentication methods consist in signing and verifying the exchanged messages between mobile objects using digital signature algorithms, such as the Elliptic Curve Digital Signature Algorithm (ECDSA). A valid digital signature guarantees that the exchanged message was generated by a known sender, that the message was not altered during its transmission, and that the sender cannot deny having generated the message.

However, digital signature algorithms induce additional communication and processing overheads that can degrade the quality of service of exchanged messages (e.g. delay), and thus can impact the safety of involved objects. This is especially true in high density networks, where each object may receive several hundred (or thousand) messages per second from neighboring objects, and which cannot all be verified in a timely manner due to the limited computational resources. As a result, several important messages from close by objects get dropped due to timeout, resulting in loss of awareness for safety applications.

Accordingly, in view of the disadvantages inherent in the conventional means of authentication between mobile objects, it has remained a constant concern to provide for more practical, more efficient, secure and cost effective means for prioritizing the authentication of exchanged messages between mobile objects (e.g. vehicles).

### SUMMARY OF THE INVENTION

In view of the foregoing disadvantages inherent in the prior art, the general purpose of the present invention is to provide an improved combination of convenience and utility for prioritized authentication between mobile objects, to include advantages of the prior art and to overcome the drawbacks inherent therein.

In one aspect, the present invention provides a system for prioritized authentication between a plurality of mobile objects. The system comprises: at least a safety application module capable of generating periodically or at specific time instants messages having at least current real-time mobility information of at least the mobile object; at least a mobility module capable of continuously tracking a real-time location information of at least the mobile object; at least a security module having at least one of a signature generation module and a signature verification module, wherein the signature generation module is capable of signing messages generated by the safety application module, wherein the signature verification module is capable of prioritizing the verification of exchanged messages between mobile objects; and at least a communication module capable of transmitting the messages signed by the security module through a network. The real-time location information includes global positioning system location, speed, and orientation.

In another aspect of the present invention, the signature verification module comprises: at least one of at least a message classifier sub-module to classify the incoming messages into their corresponding safety areas, at least a message dispatcher sub-module to dispatch the incoming messages into a multi-level priority queue (MLPQ) based on their estimated safety areas, at least a message scheduler sub-module to extract the signed messages from the multi-level-priority-queue and verifies their signatures.

In yet another aspect, the present invention provides a method for prioritized authentication between a plurality of mobile objects. The method comprises the steps of: tracking continuously a real-time location information of the mobile object; generating periodically or at specific time instants, messages which include the current real-time mobility information of the mobile object; signing messages generated by a safety application module; transmitting the signed messages from the security module through a wireless channel; classifying the incoming messages into their corresponding safety areas; dispatching the incoming messages into a multi-level priority queue (MLPQ) based on their estimated safety areas; extracting the signed messages from the multi-level-priority-queue and verifies their signatures; and verifying the message signatures.

These together with other aspects of the present invention, along with the various features of novelty that characterize the invention, are pointed out with particularity in the detailed description forming a part of this disclosure. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWING

While the specification concludes with claims that particularly point out and distinctly claim the present invention, it is believed that the expressly disclosed exemplary embodiments of the present invention can be well understood from the following detailed description taken in conjunction with the accompanying drawings. The drawings and detailed description which follow are intended to be merely illustrative of the expressly disclosed exemplary embodiments and are not intended to limit the scope of the invention as set forth in the appended claims. In the drawings:

FIG. 1 illustrates a network of a plurality of mobile objects;

FIGS. 2 and 2A illustrate a system for prioritized authentication between a plurality of mobile objects;

FIG. 3 illustrates a network of a reference mobile objects and a set of neighboring mobile objects, according to an exemplary embodiment of the present invention;

FIG. 4 illustrates a block diagram of a signature verification module for prioritizing the verification of exchanged messages between mobile objects, according to an exemplary embodiment of the present invention;

FIG. 4A illustrates an environmental diagram of the signature verification module, according to an exemplary embodiment of the present invention;

FIG. 5 illustrates a flow graph of a method for prioritized authentication between the plurality of mobile objects, according to an exemplary embodiment of the present invention;

FIG. 5A illustrates the flow graph of a method for classifying the incoming messages into their corresponding safety areas, according to an exemplary embodiment of the present invention;

FIG. 5B illustrates a flow graph of a method for dispatching the incoming messages into a multi-level priority queue (MLPQ) based on their estimated safety areas according to an exemplary embodiment of the present invention; and

FIG. 5C illustrates a flow graph of a method for verifying signatures of signed message, according to an exemplary embodiment of the present invention.

### DETAILED DESCRIPTION OF THE INVENTION

The exemplary embodiments of the present invention, described herein detail for illustrative purposes, are subject to many variations, structure and design. It should be emphasized, however that the present invention is not limited to particular method and system for prioritizing the authentication of exchanged messages between mobile objects (e.g. vehicles), as shown and described. On the contrary, a person skilled in the art will appreciate that many other embodiments of the present invention are possible without deviating from the basic concept of the present invention as the principles of the present invention can be used with a variety of methods and structural arrangements for prioritizing the authentication of exchanged messages between mobile objects. It is understood that various omissions, substitutions of equivalents are contemplated as circumstances may suggest or render expedient, but the present invention is intended to cover such alternatives, modifications, and equivalents as can be reasonably included within the scope of the present invention and any such work around will also fall under scope of the present invention without departing from the spirit or scope of the its claims.

In the following description, for purposes of explanation, numerous specific details are set forth in order to provide a thorough understanding of the present invention. It will be apparent, however, to one skilled in the art that the present invention may be practiced without these specific details.

As used herein, the term ‘plurality’ refers to the presence of more than one of the referenced item and the terms ‘a’, ‘an’, and ‘at least’ do not denote a limitation of quantity, but rather denote the presence of at least one of the referenced item. The term ‘system’ also includes ‘machine’, ‘device’, and ‘apparatus’. The term ‘signature generation module’ and ‘message signature generation module’ refers the same thing. The terms ‘signature verification module’ and ‘message signature verification module’ refers the same thing. The terms ‘mobile object’ and ‘object’ refers the same thing.

According to an exemplary embodiment, the present invention provides more practical, more efficient, secure and cost effective means for prioritizing the authentication of exchanged messages between mobile objects (e.g. vehicles).

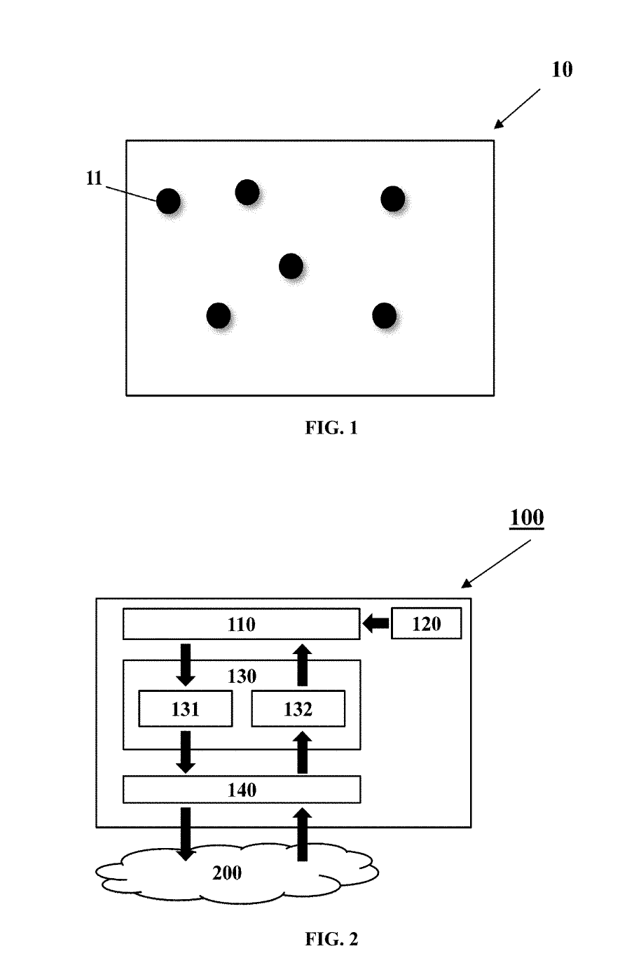

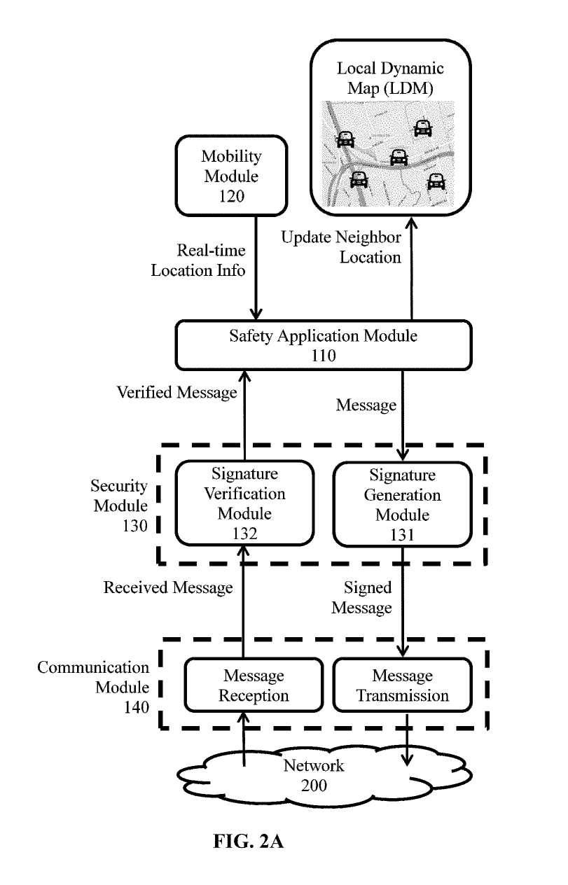

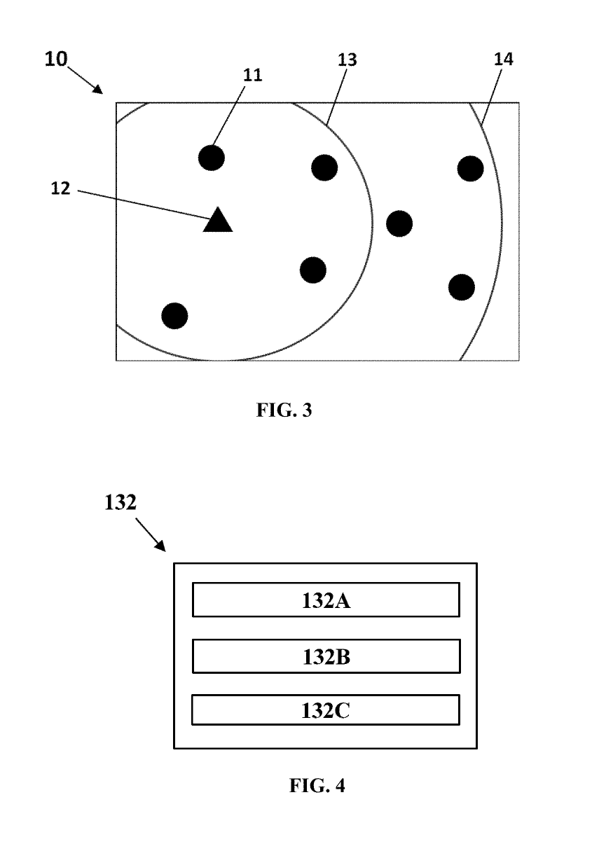

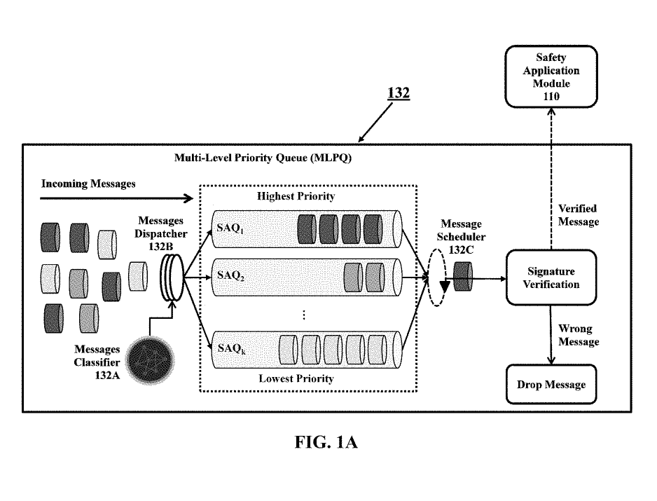

Referring to FIG. 1 which illustrates an exemplary network 10 of a plurality of mobile objects 11. The network 10 comprises the plurality of mobile objects 11, which are attached to different mobile entities, for example, vehicles, bicycles, robots, humans, animals, unmanned aerial vehicles, etc.

Each mobile object 11 is embedded with electronics and software, and capable of broadcasting messages wirelessly to notify its neighboring objects 11 about its presence and current/real-time mobility information, for example, its global positioning system location, speed, heading, orientation, etc. The broadcasting of messages may be done periodically or at specific time instants. Each mobile object 11 is capable of acting as at least one of a transmitter and a receiver.

Referring to FIGS. 2 and 2A which illustrate a system 100 for prioritized authentication between a plurality of a mobile objects 11. The system 100 comprises: at least one of at least a safety application module 110, at least a mobility module 120, at least a security module 130, at least a communication module 140 or any combination thereof. A local dynamic map (LDM) communicably connected with the safety application module 110 is capable of maintaining a clear picture of surrounding traffic. The LDM is a database that collects information from various sensors, road side units and neighborhood vehicles to facilitate various ITS applications, such as intersection collision warning, wrong way driving warning, approaching emergency vehicle warning application, etc.

The communication module 140 is capable of transmitting the messages signed by the security module 130 through a network 200. The network 200 includes at least one of a wireless network and a wired network.

The mobility module 120 is capable of continuously tracking at least the real-time location information (current mobility information) of at least the mobile object 11. The real-time location information includes global positioning system location, speed, heading, orientation, etc. This mobility information is then provided to the safety application module 110 on-request or proactively. The safety application module 110 is capable of generating periodically or at specific time instants messages which include the current real-time mobility information of at least the mobile object 11. The generated message is then forwarded to the security module 130.

The security module 130 comprises at least one of a signature generation module 131 and a signature verification module 132. The signature generation module 131 is capable of signing messages generated by the safety application module 110. The signature process consists in attaching to each generated message at least a digital signature to ensure its authenticity and integrity. Signed messages are then forwarded to the communication module 140. The communication module 140 is responsible for transmitting the signed messages from the security module 140 through the wireless channel 200.

All mobile objects 11 which are present within the communication range of the transmitter, may receive the signed messages, depending on the wireless connectivity and radio propagation conditions. When a signed message is successfully received by the communication module 140 from a neighbor mobile object 11, it is forwarded to the security module 130 (also referred to as ‘upper layer security module’) wherein the signature verification module 132 verifies the validity of received messages against their signatures. Messages that are not verified within an acceptable time frame are dropped, as well as the messages that are associated with invalid signatures. Otherwise, if signatures are valid, the corresponding messages are forwarded to the upper layer safety application module 110 (also referred to as ‘upper layer safety module’) which utilizes the received mobility information to implement safety applications, for example, to predict and avoid collisions between the mobile objects 11, etc.

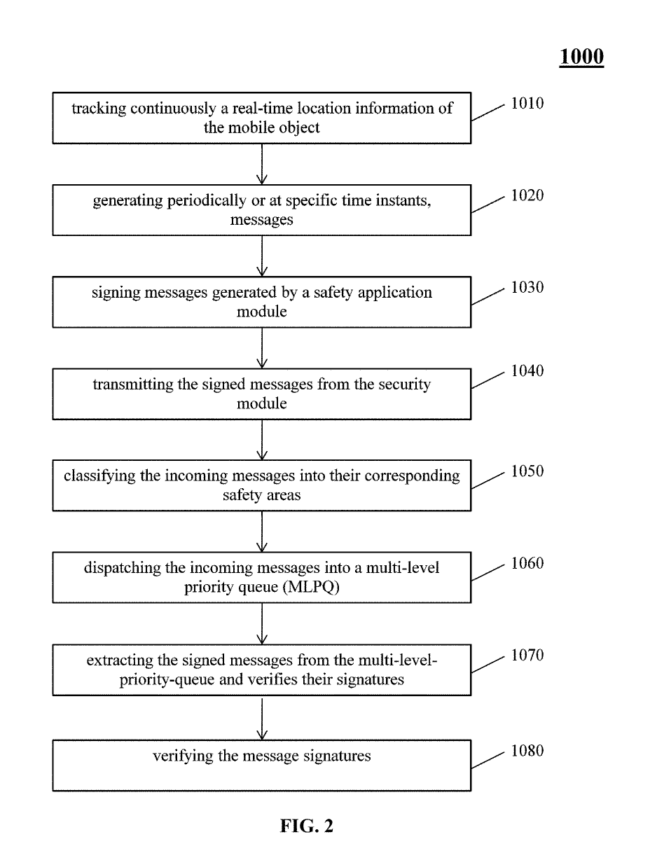

Referring now to the invention in more detail, FIG. 3 illustrates the network 10 of a reference mobile object 12 and a set of neighboring mobile objects 11. The reference mobile object 12 receives periodically, from its neighbors (i.e. mobile objects 11), a set of signed messages which may be all verified before their actual exploitation by the safety application module 110.

According to an exemplary embodiment, the present invention is capable of prioritizing the verification of the incoming signed messages based on their estimated safety areas 13 and 14 that are computed based on the messages received signal strengths, which are generally correlated with the distance between the reference mobile object 12 and the neighbors mobile objects 11.

Still referring to the reference mobile object 12, nearby mobile objects 11 represents a higher safety concern from a safety application point of view. Hence, messages that are received from nearby mobile objects 11, for example, the mobile objects that are inside the safety area 13, may be verified in priority; whereas the messages that are originating from further away mobile objects 11, for example, the mobile objects 11 that are located inside the safety area 14, may be delayed or discarded, without impacting the safety of the reference object 12.

To achieve the above goal, the present invention capable of implementing two main aspects. According to the first aspect, incoming messages have different received signal strengths in such a way that greater the distance between the reference mobile object 12 and its neighbors mobile objects 11, lower the signal strength of the received messages. According to the second aspect, based on the safety application module 110 requirements, the reference mobile object 12 capable of classifying the geographical region around them into several safety areas, for example, safety areas 13 and 14, as shown in FIG. 3.

Then, the reference mobile object 12 classifies the messages according to their received signal strengths, for example by implementing a data clustering algorithm, into their corresponding safety areas. The data clustering algorithm is disclosed at the website https://en.wikipedia.org/w/index.php?title=Cluster_analysis&oldid=727527201, which is incorporated by reference herein in its entirety for all purposes. The messages are then dispatched into a multi-level priority queue (MLPQ) in order to optimize/prioritize their verification. The MLPQ allows the mobile object to schedule the verification of received messages based on their priority classes and/or their estimated safety areas, such that high priority messages (received from nearby safety areas or mobile objects) are verified with the lowest latency possible.

Referring now to FIGS. 4 and 4A, which illustrate a block diagram and an environmental diagram of the signature verification module 132 for prioritizing the verification of exchanged messages between mobile objects 11, according to an exemplary embodiment of the present invention. The signature verification module 132 comprises at least one of at least a message classifier sub-module 132A capable of classifying the incoming messages into their corresponding safety areas, at least a message dispatcher sub-module 132B capable of dispatching the incoming messages into a multi-level priority queue (MLPQ) based on their estimated safety areas, at least a message scheduler sub-module 132C capable of extracting the signed messages from the multi-level-priority-queue and verifies their signatures by implementing a digital signature algorithm. The digital signature algorithm is disclosed at the website https://en.wikipedia.org/w/index.php?title=Digital_Signature_Algorithm&oldid=71360521 3, which is incorporated by reference herein in its entirety for all purposes.

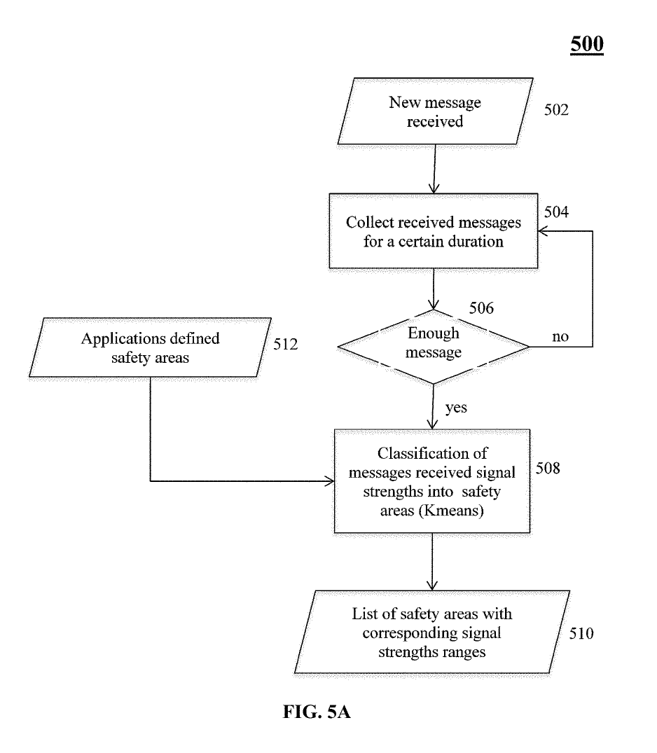

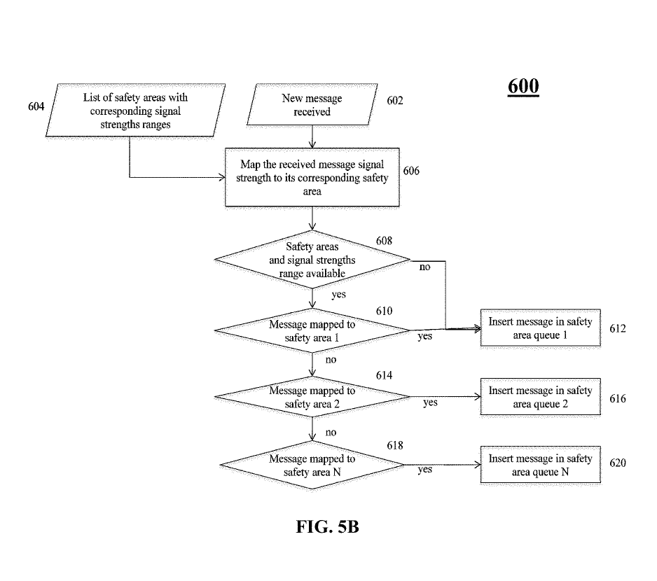

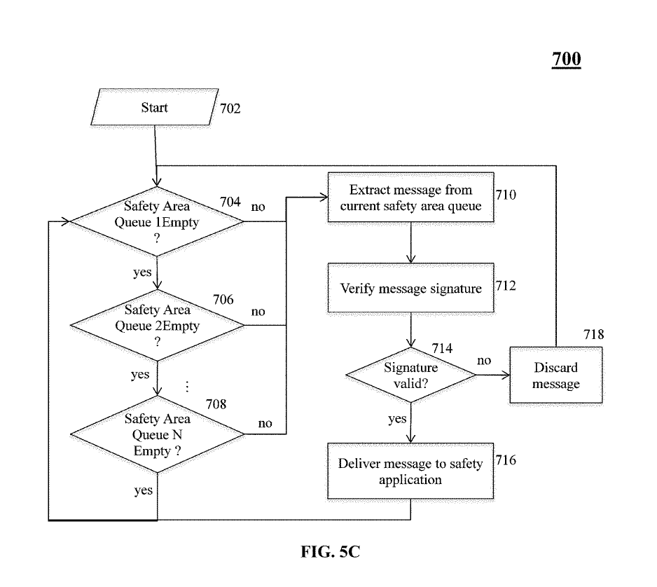

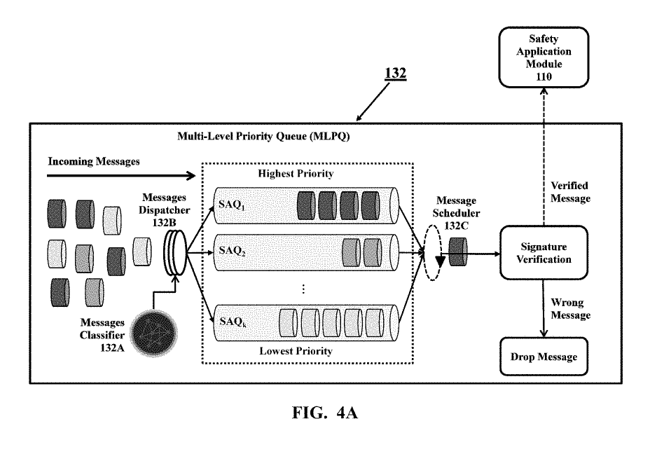

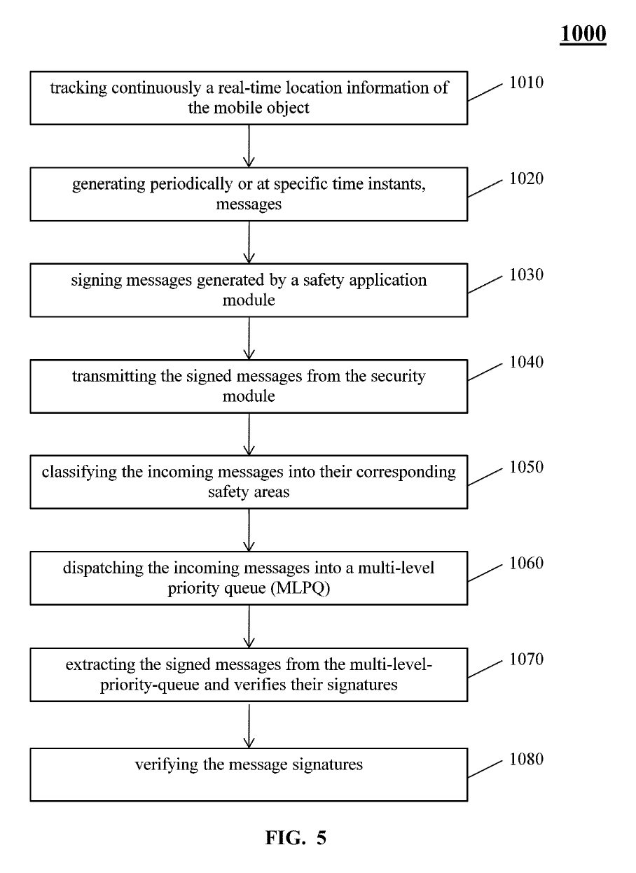

Referring to FIG. 5 which illustrates a flow graph of a method 1000 for prioritized authentication between a plurality of mobile objects 11. The method 1000 comprising the steps of: tracking continuously a real-time location information of the mobile object at a step 1010; generating periodically or at specific time instants, messages which include the current real-time mobility information of the mobile object at a step 1020; signing messages generated by a safety application module at a step 1030; transmitting the signed messages from the security module through the network at a step 1040; classifying the incoming messages into their corresponding safety areas at a step 1050; dispatching the incoming messages into a multi-level priority queue (MLPQ) based on their estimated safety areas at a step 1060; extracting the signed messages from the multi-level-priority-queue and verifies their signatures at a step 1070; and verifying the message signatures at a step 1080.

Referring to FIG. 5A which illustrates the flow graph of a method 500 for classifying the incoming messages into their corresponding safety areas by the message classifier sub-module 132A, according to an exemplary embodiment of the present invention. The method 500 comprises the steps of: receiving a new message at a step 502; collecting the received messages for a certain duration at a step 504; checking at a step 506 whether enough messages have been received at the step 502; in case of enough messages are not received at the step 502 then collecting the received messages for a certain duration at the step 504 otherwise in case of enough messages are received at the step 502 then classifying messages received signal strengths in to safety areas at a step 508 according to application defined safety areas 512; and listing of safety areas with corresponding signal strengths ranges at a step 510.

The message classifier sub-module 132A capable of classifying the incoming messages into their corresponding safety areas. To that end, a preliminary training phase is required in order to train the classifier sub-module 132A to map the range of all possible signal strengths into their corresponding safety areas. For example, incoming messages with received signal strengths between 0 dBM and −50 dBm might be associated with safety area 13; whereas other incoming messages are associated to safety area 14. Then, once a new message is received at the step 502, the message classifier sub-module 132A classifies the message into its corresponding safety area at the step 508, and forwards it the message dispatcher sub-module 132B.

The message classifier sub-module 132A takes as an input a list of received messages with associated received signal strengths as well as a list of predefined safety areas (applications dependent/defined) 512 at the step 508. An example of predefined safety areas may include Safety area 1: distance between 0 and 50 meters; Safety area 2: distance between 51 and 100 meters; Safety area 3: distance between 101 and 150 meters; Safety area 4: distance between 151 and 200 meters; Safety area 5: distance beyond 200 meters.

Then, a state-of-the-art classification algorithm may be is used to classify the received signal strengths into their corresponding safety areas. The classification algorithms include the K-Means Clustering algorithm disclosed at the website https://en.wikipedia.org/w/index.php?title=K-means_clustering&oldid=729417898, and the k-Nearest Neighbors algorithm disclosed at the website https://en.wikipedia.org/w/index.php?title=K-nearest_neighbors_algorithm&oldid=729388121, which are incorporated by reference herein in its entirety for all purposes.

Finally, the output of the message classifier sub-module 132A will be the list of predefined safety areas with their estimated signal strengths ranges (by the classification algorithm) at the step 510. The output may include: Safety area 1: signal strength >−40 dBm; Safety area 2: signal strength: −40 dBm to −50 dBm; Safety area 3: signal strength: −51 dBm to −60 dBm; Safety area 4: signal strength: −61 dBm to −70 dBm; Safety area 5: signal strength <−71 dBm.

Referring to FIG. 5B which illustrates a flow graph of a method 600 for dispatching the incoming messages into a multi-level priority queue (MLPQ) based on their estimated safety areas by the message dispatcher sub-module 132B, according to an exemplary embodiment of the present invention. The method 600 comprises the steps of: receiving a new message at a step 602; mapping the received messages signal strengths to its corresponding safety areas at a step 606 according to the list of safety areas with corresponding signal strengths ranges of a step 604 (the step 510 of FIG. 5); at a step 608, if a safety area and a signal strengths range is not available, then at a step 612 the message is inserted in a safety area queue 1 otherwise at a step 610 a check is performed to know whether the message is mapped to safety area 1; if at the step 610, the message is mapped to safety area 1, then at a step 612 the message is inserted in a safety area queue 1 otherwise at a step 614 a check is performed to know whether the message is mapped to safety area 2; if at the step 614, the message is mapped to safety area 2, then at a step 616 the message is inserted in a safety area queue 2 otherwise at a step 618 a check is performed to know whether the message is mapped to safety area N; and if at the step 618 the message is mapped to safety area N, then at a step 620 the message is inserted in a safety area queue N.

The message dispatcher sub-module 132B dispatches the incoming messages into a multi-level priority queue (MLPQ) based on their estimated safety areas. The MLPQ consists in a set of first-come-first-served (FCFS) queues, where each safety area is associated to a dedicated queue. In other words, each queue is responsible for holding the signed messages which are received at the step 602 from mobile objects 11 which are located in a specific safety area.

If available, the message dispatcher sub-module 132B takes as an input the list of safety areas and their estimated signal strengths ranges at the step 604 as computed by the message classifier sub-module 132A (at the step 510 of FIG. 5). Also, the message dispatcher sub-module 132B takes as an input the message received at the step 602. Then, based on the message received signal strength, the message is mapped to the corresponding safety area at the step 606, and then inserted into a multi-level priority queueSAQ₁, SAQ₂, . . . SAQ_{N} (as shown in FIG. 4A), where each safety area is associated to a dedicated safety area queue (SAQ).

Considering the above example of predefined safety areas with their estimated signal strengths ranges, if messages are received with signal strengths of −59 dBm and −10 dBm, they may be dispatched to safety area queue 3 and safety area queue 1, respectively.

Referring to FIG. 5C which illustrates a flow graph of a method 700 for verifying signatures of signed message by the message scheduler sub-module 132C, according to an exemplary embodiment of the present invention. The method 700 starts at a step 702 comprises the steps of: checking at a step 704, whether the safety area queue 1 is empty; if the safety area queue 1 is empty at the step 704, then at a step 706 checking whether the safety area queue 2 is empty; if the safety area queue 2 is empty at the step 706 then . . . at a step 708 checking whether the safety area queue N is empty; if the safety area queue 1, 2, . . . N is not empty at any of the steps 704, 706, . . . 708, then extracting message from current safety area queue at a step 710; verifying message signatures at a step 701; if signature valid at a step 704 then delivering message to safety application at a step 716 and restarting the loop at the step 704 by checking whether the safety area queue 1 is empty; if the signature is not valid at the step 714, then the message is discarded at a step 718 and the loop is restarted at the step 704 by checking whether the safety area queue 1 is empty.

The message scheduler sub-module 132C extracts the signed messages from the multi-level-priority-queue and verifies their signatures using the digital signature algorithm. The message scheduler sub-module 132C is based on the first-come first-served (FCFS) and round-robin scheduling techniques. The message scheduler sub-module 132C starts by checking the highest priority queue, associated with the highest priority safety area 13, for stored signed messages. If the queue is empty, the next immediate low level queue is checked. This process continues until a signed message is found.

Then, once a signed message is extracted from the MLPQ, its age is checked against a predefined timeout. This timeout aims at discarding the signed messages that contain outdated mobility information. Hence, signed messages that are not verified within an acceptable time frame, are dropped. This message loss is also known as cryptographic packet loss.

If an extracted signed message has a valid age, the message scheduler sub-module 132C verifies its signature using a digital signature algorithm. If the message signature is found to be correct, the safety application module 110 is notified, otherwise, the message is dropped.

The present invention is capable of prioritizing the verification of the received messages (e.g. BSMs, CAMs) based on the estimated safety areas that are computed using the received signal strengths. For example, from an ITS safety application point of view, nearby vehicles represent a higher safety concern. Indeed, the BSMs received from the nearest vehicles (up to 100 meters) should be verified in priority; whereas the verification of the BSMs generated by vehicles further away (beyond 100 meters) may be delayed or discarded, without impacting the safety of ITS applications.

Without limitation, the present invention has many advantages. First, by taking advantage of the fact that signed messages have different received signal strengths, especially due to the fact that neighboring mobile objects are located in different safety areas, the highest priority messages are verified with the lowest latency possible, increasing thus the awareness level of mobile objects with respects to their neighbors. Second, by prioritizing the verification of messages that are generated by nearby mobile objects, the corresponding cryptographic loss is reduced, increasing thus the accuracy of safety applications, such as collision avoidance, obstacle detection, etc.

Different aspects of the present invention are embedded with electronics and software, and are able to communicate between each other using wireless communications.

The techniques for prioritized authentication between a plurality of mobile objects 11 have been also disclosed by the inventors in the paper referenced as “E. Ben Hamida and M. A. Javed, “Channel-Aware ECDSA Signature Verification of Basic Safety Messages with K-Means Clustering in VANETs,” 2016 IEEE 30th International Conference on Advanced Information Networking and Applications (AINA), Crans-Montana, 2016, pp. 603-610. Doi: 10.1109/AINA.2016.51”, which is incorporated by reference herein in its entirety for all purposes.

In various exemplary embodiments of the present invention, the operations discussed herein, e.g., with reference to FIGS. 1 to 5C, may be implemented through computing devices such as hardware, software, firmware, or combinations thereof, which may be provided as a computer program product, e.g., including a machine-readable or computer-readable medium having stored thereon instructions or software procedures used to program a computer to perform a process discussed herein. The machine-readable medium may include a storage device. In other instances, well-known methods, procedures, components, and circuits have not been described herein so as not to obscure the particular embodiments of the present invention. Further, various aspects of embodiments of the present invention may be performed using various means, such as integrated semiconductor circuits, computer-readable instructions organized into one or more programs, or some combination of hardware and software.

Although particular exemplary embodiments of the present invention has been disclosed in detail for illustrative purposes, it will be recognized to those skilled in the art that variations or modifications of the disclosed invention, including the rearrangement in the configurations of the parts, changes in sizes and dimensions, variances in terms of shape may be possible. Accordingly, the invention is intended to embrace all such alternatives, modifications and variations as may fall within the spirit and scope of the present invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

We claim:

1. A system for prioritized authentication between a plurality of mobile objects, comprising:
at least a safety application module capable of generating periodically or at specific time instants messages having at least current real-time mobility information of at least the mobile object;
at least a mobility module capable of continuously tracking a real-time location information of at least the mobile object;
at least a security module having at least one of a signature generation module and a signature verification module, wherein the signature generation module is capable of signing messages generated by the safety application module, wherein the signature verification module is capable of prioritizing the verification of exchanged messages between mobile objects; and
at least a communication module capable of transmitting the messages signed by the security module through a network.

2. The system of claim 1, wherein mobile objects broadcasting messages wirelessly periodically or at specific time instants to notify its neighboring objects about its presence and mobility information, wherein the mobile object is capable of acting as at least one of a transmitter and a receiver.

3. The system of claim 1, wherein the mobile entities include vehicles, bicycles, robots, humans, animals, unmanned aerial vehicles.

4. The system of claim 1, wherein the signature verification module comprising:
at least one of at least a message classifier sub-module to classify the incoming messages into their corresponding safety areas;
at least a message dispatcher sub-module to dispatch the incoming messages into a multi-level priority queue (MLPQ) based on their estimated safety areas; and
at least a message scheduler sub-module to extract the signed messages from the multi-level-priority-queue and verifies their signatures using a digital signature algorithm.

5. A method for prioritized authentication between a plurality of mobile objects, comprising the steps of:
tracking continuously a real-time mobility information of the mobile object;
generating periodically or at specific time instants, messages which include the real-time mobility information of the mobile object;
signing messages generated by a safety application module;
transmitting the signed messages from the security module through a network;
classifying the incoming messages into their corresponding safety areas;
dispatching the incoming messages into a multi-level priority queue (MLPQ) based on their estimated safety areas;
extracting the signed messages from the multi-level-priority-queue and verifies their signatures; and
verifying the message signatures.

6. The method of claim 5, wherein a message classifier sub-module classify the incoming messages into their corresponding safety areas and map the range of all possible signal strengths into their corresponding safety areas.

7. The method of claim 5, wherein the message dispatcher sub-module dispatches the incoming messages into a multi-level priority queue (MLPQ) based on their estimated safety areas, wherein the MLPQ consists in a set of first-come-first-served (FCFS) queues such that each safety area is associated to a dedicated queue.

8. The method of claim 5, wherein the message dispatcher sub-module takes as an input a list of safety areas and their estimated signal strengths ranges as computed by the message classifier sub-module, also takes as an input a received message.

9. The method of claim 5, wherein the message dispatcher sub-module based on the message received signal strength, it is mapped to the corresponding safety area, and is inserted into a multi-level priority queue, wherein each safety area is associated to a dedicated safety area queue (SAQ).

10. The method of claim 5, wherein a message scheduler sub-module extracts signed messages from a multi-level-priority-queue and verifies their signatures.

11. The method of claim 10, wherein the message scheduler sub-module is based on the first-come first-served (FCFS) and round-robin scheduling techniques.

12. The method of claim 10, wherein the message scheduler sub-module starts by checking the highest priority queue, associated with the highest priority safety area, for stored signed messages.

13. The method of claim 10, wherein the message scheduler sub-module verifies its signature using a digital signature algorithm, wherein if the message signature is found to be correct, the safety application module is notified, otherwise, the message is dropped.

14. The method of claim 5, wherein all objects which are present within a communication range of a transmitter, may receive the signed messages, depending on the wireless connectivity and radio propagation conditions.

15. The method of claim 5, wherein when a signed message is successfully received by a communication module from a neighbor object, it is forwarded to an upper layer security module which comprises a signature verification module 132.

16. The method of claim 15, wherein the signature verification module verifies the validity of received messages against their signatures, wherein messages that are not verified within an acceptable time frame are dropped, as well as the messages that are associated with invalid signatures, wherein if signatures are valid, the corresponding messages are forwarded to the upper layer safety application module which utilizes the received mobility information to implement safety applications.

17. The method of claim 5, wherein at least a reference object receives periodically, from its neighbors a set of signed messages which be all verified before their actual exploitation by the safety application module.

18. The method of claim 5, wherein a prioritized verification of the incoming signed messages is based on their estimated safety areas that are computed based on the messages received signal strengths.

19. The method of claim 5, wherein incoming messages have different received signal strengths in such a way that greater the distance between the reference mobile object and its neighbors mobile objects, lower the signal strength of the received messages.

20. The method of claim 5, wherein based on the safety application module requirements, a reference mobile object classifies the geographical region around him into several safety areas.
